(19) United States
(12) Patent Application Publication
(10) Pub. No.: US 2026/0098581 A1
(43) Pub. Date: Apr. 9, 2026

(54) VALVE

(71) Applicants: Hyundai Motor Company, Seoul (KR); Kia Corporation, Seoul (KR)

(72) Inventors: In Tae Park, Hwaseong-si (KR); Gyu Young Kim, Hwaseong-si (KR)

(21) Appl. No.: 19/216,985

(22) Filed: May 23, 2025

(30) Foreign Application Priority Data
Oct. 8, 2024 (KR) 10-2024-0137128

(51) Int. Cl. F16K 1/22; F16K 31/06

(52) U.S. Cl. CPC F16K 1/222; F16K 1/221; F16K 31/0655

(57) ABSTRACT

A valve can include a valve body formed to allow a fluid to flow and forming a flow path including a portion extending in a first direction, a solenoid coil mounted on the valve body to surround the flow path outside the flow path, and a valve cover including a valve disc configured to open or close the flow path by the solenoid coil, wherein the valve disc comprises a magnetic material, and wherein the valve disc is rotatably provided on the flow path, a disc holder area rotatably supporting the valve disc, and a cover area mounted on the valve body to cover one side of the flow path in the first direction and supporting the disc holder area.

### CROSS-REFERENCE TO RELATED APPLICATIONS

This application claims the benefit of priority to Korean Patent Application No. 10-2024-0137128, filed in the Korean Intellectual Property Office on Oct. 8, 2024, the entire contents of which are incorporated herein by reference.

### TECHNICAL FIELD

The present disclosure relates to a valve.

### BACKGROUND

A valve may be a device that adjusts flow of a fluid by opening or closing a flow path through which the fluid flows. The valve may be classified into a butterfly valve that adjusts the flow of the fluid by installing a rotary shaft of a disc-shaped valve disc and rotating the rotary shaft and a solenoid valve formed to open or close the valve using a magnetic force by winding a conductive wire in a spiral shape and applying electricity.

The butterfly valve may be provided in an electric manner, and in this case, because a motor and a reducer should be provided together, manufacturing costs may be increased. Further, in the solenoid valve, it is difficult to manufacture the valve having the flow path having a relatively large diameter.

In this regard, the need for the valve that may be manufactured such that the diameter of the flow path is relatively large and manufacturing costs are relatively low is increasing.

The valve may include a valve body having a flow path formed therein and a bobbin body including a solenoid, and for manufacturing reasons, one side may be formed in an open shape in a process of forming the flow path in the valve body.

Accordingly, the need for the valve that improves airtightness and assemblability between the valve cover covering one side of the valve body and the valve body is increasing.

### SUMMARY

An embodiment of the present disclosure can solve the above-mentioned problems occurring in the prior art while advantages achieved by the prior art can be maintained intact.

An embodiment of the present disclosure can provide a valve having improved assemblability of a valve cover and a valve body while airtightly sealing the valve cover covering one side of the valve body and the valve body.

Technical problems to be solved by an embodiment of the present disclosure are not necessarily limited to the aforementioned problems, and solutions to other technical problems not mentioned herein by an embodiment of the present disclosure can be understood from the following description by those skilled in the art to which the present disclosure pertains.

According to an embodiment of the present disclosure, a valve can include a valve body having a flow path for fluid flow, the flow path including a portion extending in a first direction, a solenoid coil located in the valve body to surround the flow path outside the flow path, and a valve cover including a valve disc configured to open or close the flow path by the solenoid coil, the valve disc including a magnetic material, and the valve disc is rotatably provided on the flow path, a disc holder area rotatably supporting the valve disc, and a cover area mounted on the valve body to cover one side of the flow path in the first direction and supporting the disc holder area.

The disc holder area may be inserted into the flow path from the one side of the flow path in the first direction.

The disc holder area may be disposed between the cover area and the valve body in the first direction.

The disc holder area may include a rotary shaft extending in a second direction intersecting the first direction and rotatably supporting the valve disc.

The valve disc may have a shape configured to cover the flow path, and the valve disc is configured to rotate about the rotary shaft between a closed position at which the flow path is closed by the valve disc and an open position at which the flow path is open.

The disc holder area may include a support area supporting opposite ends of the rotary shaft and in contact with an inner surface of the valve body.

The support area may include a first support area supporting a first end of the rotary shaft and a second support area supporting a second end of the rotary shaft and disposed in parallel with the first support area.

The valve may further include an open stopper member supported by the support area and extending in parallel to the rotary shaft, wherein, with a direction in which the valve disc is rotated from the closed position to the open position being referred to as a first rotational direction, the open stopper member may be configured to interfere with the valve disc to prevent the valve disc located at the open position from further rotating in the first rotational direction.

As viewed from a state of being spaced apart in the second direction, the open stopper member may be in contact with one surface of the valve disc located at the open position.

The valve body may include a first inner surface defining the flow path and in contact with the support area from a radially outer side of the flow path, a second inner surface formed on an other side of the first inner surface in the first direction and protruding toward a center of the flow path further than the first inner surface, and a fixing surface connecting the first inner surface and the second inner surface and in contact with one end of the support area.

The disc holder area may further include a closed stopper area spaced apart from the rotary shaft in a third direction, the third direction intersects the first direction and the second direction, and with a direction in which the valve disc is rotated from the open position to the closed position being referred to as a second rotational direction, the closed stopper area being configured to interfere with the valve disc to prevent the valve disc located at the closed position from further rotating in the second rotational direction.

As viewed in a state of being spaced apart in the second direction, the closed stopper area may be in contact with one surface of the valve disc located at the closed position.

The valve cover may further include a support connection area connecting the cover area and the support area, and at least two of the cover area, the support connection area, and the support area may be integral.

The valve cover may further include a stopper connection area connecting the cover area and a closed stopper area, and at least two of the cover area, the stopper connection area, and the closed stopper area may be integral.

The valve disc may include a rotation guide area connected to the rotary shaft and a disc area supported by the rotation guide area and formed of the magnetic material.

The valve may further include an O-ring disposed between the valve body and the valve cover.

The valve cover may include a cover hole extending in the first direction, the valve body may include a body hole communicating with the cover hole, the valve may further include a coupling member inserted into the cover hole and the body hole, and the valve cover and the valve body may be coupled to each other by the coupling member.

The cover area may include a portion inserted into the valve body and formed as a bolt, and the cover area may be coupled to the valve body inside the flow path.

The valve body or the cover area may further include an interference protrusion protruding toward the disc holder area to prevent the disc holder area from rotating about a center of the flow path.

The valve may further include a bobbin body provided outside the valve body to surround the solenoid coil, wherein the valve body and the bobbin body may be integral.

### BRIEF DESCRIPTION OF THE DRAWINGS

The above and other features and advantages of example embodiments of the present disclosure can be more apparent from the following detailed description taken in conjunction with the accompanying drawings, in which:

FIG. 1 is a perspective view of a valve according to an embodiment of the present disclosure;

FIG. 2 is a vertical cross-sectional view of a valve when a valve disc is in a closed state according to an embodiment of the present disclosure;

FIG. 3 is a vertical cross-sectional view of a valve when a valve disc is in an open state according to an embodiment of the present disclosure;

FIG. 4 is a horizontal cross-sectional view of a valve when a valve disc is in a closed state according to an embodiment of the present disclosure;

FIG. 5 is a horizontal cross-sectional view of the valve when a valve disc is in an open state according to an embodiment of the present disclosure;

FIG. 6 is a vertical cross-sectional view of a valve when a valve disc is in a closed state according to an embodiment of the present disclosure;

FIG. 7 is a vertical cross-sectional view of a valve when a valve disc is in an open state according to an embodiment of the present disclosure;

FIG. 8 is a horizontal cross-sectional view of a valve when a valve disc is in a closed state according to an embodiment of the present disclosure; and

FIG. 9 is a horizontal cross-sectional view of a valve when a valve disc is in an open state according to an embodiment of the present disclosure.

FIG. 10 is a vertical cross-sectional view of a valve when a valve disc is in a closed state according to an embodiment of the present disclosure.

### DETAILED DESCRIPTION OF ILLUSTRATIVE EMBODIMENTS

Hereinafter, some example embodiments of the present disclosure will be described in detail with reference to the drawings. In adding reference numerals to components of each drawing, identical or equivalent components can be designated by an identical numeral even when they are displayed on other drawings. In describing example embodiments of the present disclosure, a detailed description of the related known configuration or function can be omitted when it is determined that the detailed description might interfere with an understanding of the example embodiment of the present disclosure.

In describing components of the example embodiments of the present disclosure, terms, such as “first,” “second,” “A”, “B”, “(a)”, and “(b)” may be used. Such terms can be merely intended to distinguish one component from other components, and such terms do not necessarily limit the nature, order, or sequence of the components. Unless otherwise defined, terms including technical and scientific terms used herein can have same meanings as commonly understood by one of ordinary skill in the art to which the present disclosure belongs. Terms, such as those defined in commonly used dictionaries, can be interpreted as having meanings that are consistent with their meanings in the context of the relevant art.

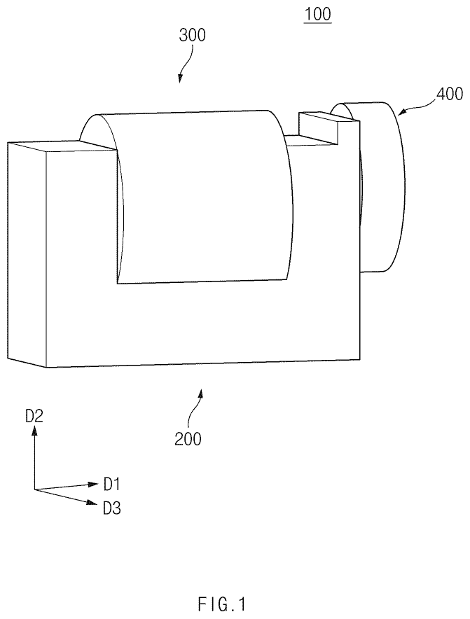

Hereinafter, example embodiments of the present disclosure will be described in detail with reference to FIGS. 1 to 9.

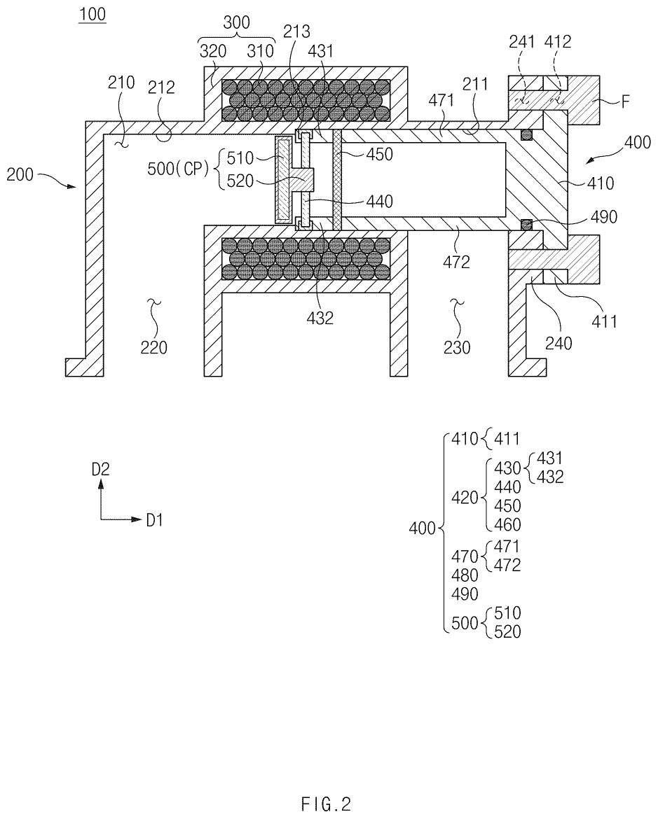

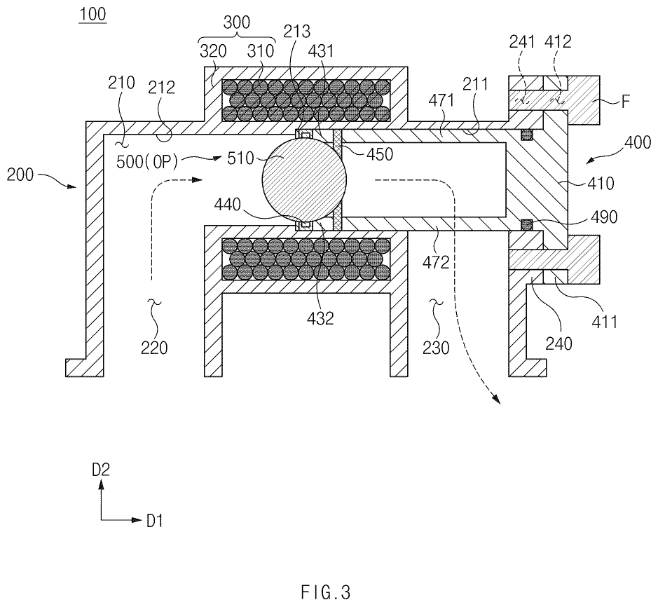

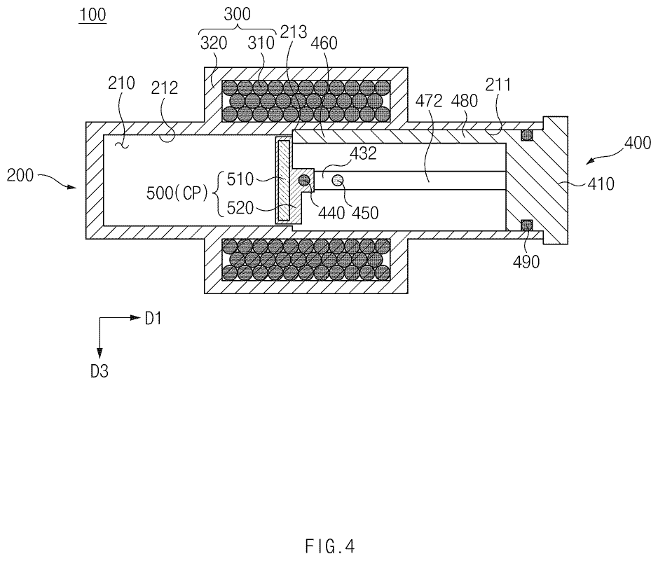

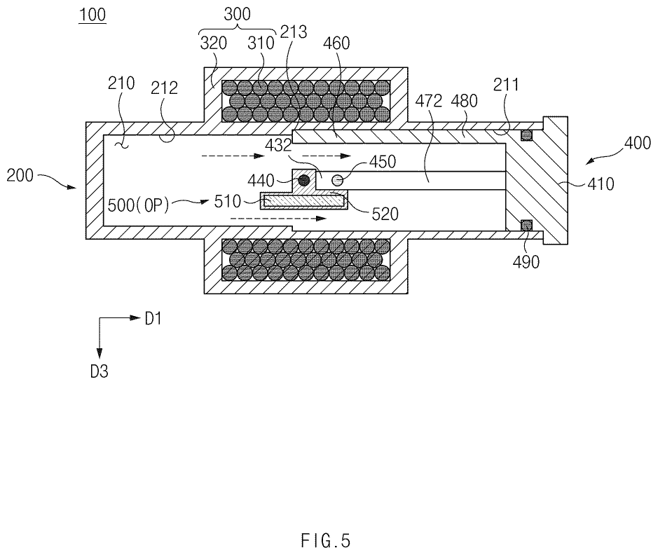

FIG. 1 is a perspective view of a valve according to an embodiment of the present disclosure. FIG. 2 is a vertical cross-sectional view of a valve when a valve disc is in a closed state according to an embodiment of the present disclosure. FIG. 3 is a vertical cross-sectional view of a valve when a valve disc is in an open state according to an embodiment of the present disclosure. FIG. 4 is a horizontal cross-sectional view of a valve when a valve disc is in a closed state according to an embodiment of the present disclosure. FIG. 5 is a horizontal cross-sectional view of a valve when a valve disc is in an open state according to an embodiment of the present disclosure.

Referring to FIGS. 1 to 5, a valve 100 may be a device for opening/closing a flow path 210 through which a fluid such as hydrogen flows.

The valve 100 may include a valve body 200 formed such that the fluid flows and forming the flow path 210 including a portion extending in a first direction (D1 or an opposite direction to D1) and a solenoid module 300 mounted on the valve body 200 to surround the flow path 210 from an outside of the flow path 210.

A process of removing a mold from one side D1 of the valve body 200 in the first direction toward an inside of the valve body 200 may be used to form the flow path 210 inside the valve body 200.

When such a process is performed, one side D1 of the flow path 210 in the first direction may be formed to be open. To close the one side D1 of the flow path 210 in the first direction, the valve 100 may further include a valve cover 400 mounted on the valve body 200.

The valve body 200 may include an inlet 220 communicating with the flow path 210 to supply the fluid to the flow path 210 and an outlet 230 that discharges the fluid from the flow path 210. The inlet 220 and the outlet 230 may be located at opposite ends of the flow path 210 with respect to a flow direction of the fluid.

The solenoid module 300 may include a solenoid coil 310 mounted on the valve body 200 to surround the flow path 210 from the outside of the flow path 210 and a bobbin body 320 formed in a hollow cylindrical shape to surround the solenoid coil 310.

The bobbin body 320 may be provided outside the valve body 200 and may be formed to surround the solenoid coil 310. The solenoid coil 310 provided inside the bobbin body 320 may be sealed.

Although not separately illustrated in the drawing, the solenoid coil 310 may receive external power through a connector, and thus a current may be applied thereto. The bobbin body 320 according to an embodiment of the present disclosure may be formed integrally with the valve body 200.

The valve cover 400 may include a cover area 410 mounted on the valve body 200 to cover the one side D1 of the flow path 210 in the first direction, and a disc holder area 420 supported by the cover area 410 and provided inside the flow path 210.

The valve cover 400 may include a valve disc 500 formed of a magnetic material to open or close the flow path 210 by the solenoid coil 310 and rotatably provided on the flow path 210.

The cover area 410 and the disc holder area 420 of the valve cover 400 according to an embodiment of the present disclosure may be integrally formed.

The cover area 410 may be a part mounted on the one side D1 of the valve body 200 in the first direction to cover one surface of the flow path 210.

The disc holder area 420 may be a part inserted into the flow path 210 from the cover area 410. In other words, the disc holder area 420 may be inserted into the flow path 210 from the one side D1 of the flow path 210 in the first direction. The disc holder area 420 may rotatably support the valve disc 500.

The disc holder area 420 may be disposed between the cover area 410 and the valve body 200 in the first direction (D1 or the opposite direction to D1).

In more detail, the valve body 200 may include a first inner surface 211 that defines the flow path 210 and is disposed outside the valve cover 400 in a radial direction and a second inner surface 212 that is formed on the other side (the opposite direction to D1) of the first inner surface 211 in the first direction and protrudes toward a center of the flow path 210 further than the first inner surface 211. Further, the valve body 200 may include a fixing surface 213 connecting the first inner surface 211 and the second inner surface 212.

As the disc holder area 420 comes into contact with the fixing surface 213, a position at which the valve cover 400 is inserted into the valve body 200 may be guided. In other words, the disc holder area 420 may be inserted from the one side D1 of the flow path 210 in the first direction to the other side (the opposite direction to D1) of the first direction, may then come into contact with the fixing surface 213, and thus may prevent insertion into the other side (the opposite direction to D1) of the first direction.

The disc holder area 420 may be disposed between the cover area 410 and the fixing surface 213 of the valve body 200 in the first direction (D1 or the opposite direction to D1), and the disc holder area 420 may be supported by the cover area 410.

Due to the structure, the position at which the valve cover 400 is inserted into the valve body 200 may be guided. Thereafter, when only the cover area 410 and the valve body 200 are coupled, the disc holder area 420 and the valve disc 500 may be stably supported inside the flow path 210 even without a separate structure. Accordingly, the structure of the valve 100 may be simplified, thereby reducing costs and a weight of the valve 100.

The disc holder area 420 may rotatably support the valve disc 500. The disc holder area 420 may include a support area 430, a rotary shaft 440, an open stopper member 450, and a closed stopper area 460.

The support area 430 may support opposite ends of the rotary shaft 440 and may be in contact with the first inner surface 211 of the valve body 200. The first inner surface 211 may be in contact with the support area 430 outside the flow path 210 in the radial direction to support the support area 430.

The support area 430 may include a first support area 431 supporting one end of the rotary shaft 440 and a second support area 432 supporting the other end of the rotary shaft 440 and disposed in parallel with the first support area 431.

The first support area 431 and the second support area 432 may be supported by the first inner surface 211 of the valve body 200 in a radially outward direction. One end of the first support area 431 and the second support area 432 toward the other side (opposite direction to D1) of the first direction may be in contact with the fixing surface 213, and positions thereof may be fixed by the fixing surface 213.

The rotary shaft 440 may extend in a second direction (D2 or an opposite direction to D2) intersecting the first direction (D1 or the opposite direction to D1), and opposite ends thereof may be supported by the first support area 431 and the second support area 432. The rotary shaft 440 may rotatably support the valve disc 500.

The open stopper member 450 may be disposed on the one side D1 of the first direction further than the rotary shaft 440 and may extend in parallel with the rotary shaft 440. That is, the open stopper member 450 may extend in the second direction (D2 or the opposite direction to D2). Opposite ends of the open stopper member 450 may be supported by the first support area 431 and the second support area 432.

The closed stopper area 460 may be connected to the cover area 410 and may be spaced apart from the rotary shaft 440 in a third direction (D3 or an opposite direction to D3). Here, the third direction (D3 or the opposite direction to D3) may be a direction intersecting both the first direction (D1 or the opposite direction to D1) and the second direction (D2 or the opposite direction to D2).

The closed stopper area 460 may extend in the first direction (D1 or the opposite direction to D1). An outer circumferential surface of the closed stopper area 460 may be in contact with the first inner surface 211 of the valve body 200 from a radially outer side of the flow path 210. One end of the closed stopper area 460 in the first direction (D1 or the opposite direction to D1) may be in contact with the fixing surface 213 to prevent the closed stopper area 460 from being further inserted into the other side of the first direction (D1 and the opposite direction to D1).

The closed stopper area 460, the first support area 431, and the second support area 432 may be formed to be spaced apart from each other in a circumferential direction when viewed from the one side D1 of the first direction. In other words, the closed stopper area 460, the first support area 431, and the second support area 432 may extend to the other side (the opposite direction to D1) of the first direction while being spaced apart from each other in the circumferential direction from the cover area 410.

In this example, the valve cover 400 may include a support connection area 470 connecting the cover area 410 and the support area 430 and a stopper connection area 480 connecting the cover area 410 and the closed stopper area 460.

The support connection area 470 may include a first support connection area 471 connecting the cover area 410 and the first support area 431 and a second support connection area 472 connecting the cover area 410 and the second support area 432.

At least two of the cover area 410, the support connection area 470, and the support area 430 may be integrally formed. According to an embodiment of the present disclosure, all the cover area 410, the support connection area 470, and the support area 430 may be integrally formed.

At least two of the cover area 410, the stopper connection area 480, and the closed stopper area 460 may be integrally formed. According to an embodiment of the present disclosure, all the cover area 410, the stopper connection area 480, and the closed stopper area 460 may be integrally formed.

The valve disc 500 may be formed in a shape covering the flow path 210. When viewed from the other side (the opposite direction to D1) of the first direction, a cross section of the valve disc 500 may cover a cross-sectional area of the flow path 210 defined by the first inner surface 211 to close the flow path 210.

The valve disc 500 may include a disc area 510 and a rotation guide area 520. The disc area 510 may be made of a magnetic material and supported by the rotation guide area 520. The rotation guide area 520 may be connected to the rotary shaft 440 while surrounding the disc area 510.

The valve disc 500 may rotate about the rotary shaft 440 between a closed position CP at which the flow path 210 is closed and an open position OP at which the flow path 210 is open. The valve disc 500 may be rotated from the closed position CP to the open position OP or rotated from the open position OP to the closed position CP.

A direction in which the valve disc 500 is rotated from the closed position CP to the open position OP may be referred to as a first rotational direction, and a direction in which the valve disc 500 is rotated from the open position OP to the closed position CP may be referred to as a second rotational direction.

The first rotational direction and the second rotational direction may be opposite to each other. The closed position CP of the valve disc 500 may be a position in which the valve disc 500 is disposed in a direction perpendicular to the flow direction of the fluid as illustrated in FIG. 4.

The open position OP of the valve disc 500 may be a position in which the valve disc 500 is disposed in a direction parallel to the flow direction of the fluid as illustrated in FIG. 5.

For a structure of an embodiment, the disc area 510 may be formed of a magnetic material to be rotated by the solenoid coil 310, and the rotation guide area 520 may rotatably support the disc area 510.

The disc area 510 may have a magnetic field formed at opposite poles to each other and may be provided in a cylindrical disc shape. The disc area 510 may include a first surface facing an upstream side with respect to the flow direction of the fluid at the closed position CP and a second surface, which is a rear surface of the first surface, facing a downstream side with respect to the flow direction of the fluid at the closed position CP.

As illustrated in FIG. 4, when viewed from a direction of the rotary shaft 440 at the closed position CP, the valve disc 500 may be partitioned by the first support area 431 and the second support area 432 and include a first pole part facing the other side (the opposite direction to D3) of the third direction and a second pole part facing the one side D3 of the third direction.

The first pole part provided as a first pole (e.g., an N pole) and the second pole provided as a second pole (e.g., an S pole) opposite to the first pole may be arranged in opposite directions. The first pole and the second pole may be one and the other one of the N pole and the S pole.

When the first pole part is an N pole and the second pole part is an S pole, a position of the valve disc 500 may be fixed as the closed position CP or the valve disc 500 may rotate toward the open position OP according to a direction of a current flowing into the solenoid coil 310.

When the valve disc 500 is positioned at the closed position CP, the first pole part may be supported by the closed stopper area 460. When viewed from the other side (the opposite direction to D1) of the first direction, when a current is applied clockwise through the solenoid coil 310, a magnetic field of the second pole (e.g., the S pole) may be induced in an upstream side with respect to the flow direction of the fluid, and a magnetic field of the first pole (e.g., the N pole) may be induced in a downstream side with respect to the flow direction of the fluid.

In this example, an area located at an upstream side of the flow direction of the fluid further than the first pole part of the valve disc 500 may be offset by the magnetic field induced by the solenoid coil 310 to form a sparse magnetic field area.

An area located at a downstream side of the flow direction of the fluid from the first pole part of the valve disc 500 may be reinforced by the magnetic field induced by the solenoid coil 310 to form a dense magnetic field area.

An area located at an upstream side of the flow direction of the fluid further than the second pole part of the valve disc 500 may be reinforced by the magnetic field induced by the solenoid coil 310 to form a dense magnetic field area.

An area located at a downstream side of the flow direction of the fluid further than the second pole part of the valve disc 500 may be offset by the magnetic field induced by the solenoid coil 310 to form a sparse magnetic field area.

Thus, when viewed in a state of being spaced in the second direction (D2 or the opposite direction to D2), the first pole may be spaced apart from the closed stopper area 460 and rotate counterclockwise, and the second pole may also rotate counterclockwise toward the open stopper member 450. In this example, a rotational direction of the valve disc 500 may be the first rotational direction.

When the rotation of the valve disc 500 in the first rotational direction starts, the flow of the fluid through the flow path 210 may start. When the first rotational direction of the valve disc 500 continues, the valve disc 500 may interfere with the open stopper member 450 as illustrated in FIG. 3 or 5.

In other words, the open stopper member 450 may prevent the valve disc 500 located at the open position OP from being rotated in the first rotational direction. When viewed in a state of being spaced apart in the second direction (D2 or the opposite direction to D2), the open stopper member 450 may be in contact with a second surface of the valve disc 500 located at the open position OP.

In this example, when viewed from a state of being spaced apart in the second direction (D2 or the opposite direction to D2), the rotary shaft 440 may be disposed to pass through the center of the flow path 210 with respect to the third direction (D3 or the opposite direction to D3). Thus, when the valve disc 500 is located at the open position OP, the disc area 510 may be disposed offset from the center with respect to the third direction (D3 or the opposite direction to D3) inside the flow path 210.

In contrast, when viewed from the other side (the opposite direction to D1) of the first direction, when a current is applied counterclockwise through the solenoid coil 310, the magnetic field of the first pole (e.g., the N pole) may be induced in the upstream side with respect to the flow direction of the fluid, and the magnetic field of the second pole (e.g., the S pole) may be induced in the downstream side with respect to the flow direction of the fluid.

In this example, an area located at the other side (the opposite direction to D3) of the third direction further than the first pole part of the valve disc 500 may be relatively strongly offset by the magnetic field induced by the solenoid coil 310 to form a sparse magnetic field area.

An area located at the one side D3 of the third direction further than the first pole part of the valve disc 500 may be relatively weakly offset by the magnetic field induced by the solenoid coil 310 to form a dense magnetic field area.

An area located at the other side (the opposite direction to D3) of the third direction further than the second pole part of the valve disc 500 may be relatively reinforced by the magnetic field induced by the solenoid coil 310 to form a dense magnetic field area.

An area located at the one side D3 of the third direction further than the second pole part of the valve disc 500 may be offset by the magnetic field induced by the solenoid coil 310 to form a sparse magnetic field area.

Thus, when viewed from a state of being spaced apart from the one side D2 in the second direction, the second pole part may be spaced apart from the open stopper member 450 and rotate clockwise, and the first pole part may also rotate clockwise toward the closed stopper area 460. In this case, a rotational direction of the valve disc 500 may be the second rotational direction.

When the rotation of the valve disc 500 in the second rotational direction starts, the flow of the fluid through the flow path 210 may be delayed. When the second rotational direction of the valve disc 500 continues, the valve disc 500 may interfere with the closed stopper area 460 as illustrated in FIG. 4.

In other words, the closed stopper area 460 may prevent the valve disc 500 located at the closed position CP from being rotated in the second rotational direction. When viewed in a state of being spaced apart in the second direction (D2 or the opposite direction to D2), the closed stopper area 460 may be in contact with a second surface of the valve disc 500 located at the closed position CP.

According to the above-described structure, the rotation of the valve disc 500 may be guided between the closed position CP at which the flow path 210 is closed and the open position OP at which the flow path 210 is open inside the flow path 210.

Portions of the first pole part and the second pole part of the disc area 510 are not limited thereto, and the disc area 510 may be divided into a first pole part facing a first surface of the valve disc 500 and a second pole part facing a second surface thereof based on FIG. 4.

The positions of the valve disc 500 at the closed position CP and the open position OP may be fixed without a separate structure, and thus the flow of the fluid may be smoothly allowed or prevented.

While the valve disc 500 is located in the closed position CP, the flow of the fluid through the flow path 210 may be prevented, and in this example, the fluid may stagnate and be frozen in a portion adjacent to the valve disc 500. In this example, when a high voltage is applied to the solenoid coil 310, the fluid flowing through the flow path 210 may be thawed.

Even for thawing the fluid, the valve body 200 and the bobbin body 320 may be integrally formed rather than a structure in which the valve body 200 and the bobbin body 320 are provided separately.

According to a structure of an embodiment, a high voltage can be applied to the solenoid coil 310 so that the frozen fluid at a portion adjacent to the valve disc 500 may be thawed by using heat generated by the solenoid coil 310 without a separate heater or the like.

The cover area 410 may include a flange area 411 provided outside the valve body 200 and extending radially outward from the center of the flow path 210. The flange area 411 may include a cover hole 412 extending in the first direction (D1 or the opposite direction to D1).

The valve body 200 may include a coupling area 240 coupled to the flange area 411. One surface of the coupling area 240 may be in contact with one surface of the flange area 411. The coupling area 240 may include a body hole 241 communicating with the cover hole 412.

A coupling member “F” may be inserted through the cover hole 412 and the body hole 241, and the valve body 200 and the valve cover 400 may be coupled to each other by the coupling member “F.” The valve 100 may include the coupling member “F” for coupling the valve cover 400 and the valve body 200.

The valve cover 400 may include an O-ring 490 provided between the cover area 410 and the coupling area 240 of the valve body 200. The O-ring 490 may seal a gap between the cover area 410 and the valve body 200.

Due to this structure of an embodiment, even in the case of a fluid, such as hydrogen, that can requires high airtightness, it can be possible to smoothly flow the fluid or prevent the flow through the valve 100, and thus usability of the valve 100 may be improved.

The cover area 410 may include an O-ring groove provided on an outer circumferential surface of a portion of the cover area 410 inserted into the valve body 200. The O-ring groove may extend in the circumferential direction. The O-ring groove may be formed such that the O-ring 490 is inserted thereinto. The O-ring 490 may be compressed by the coupling area 240 and the cover area 410.

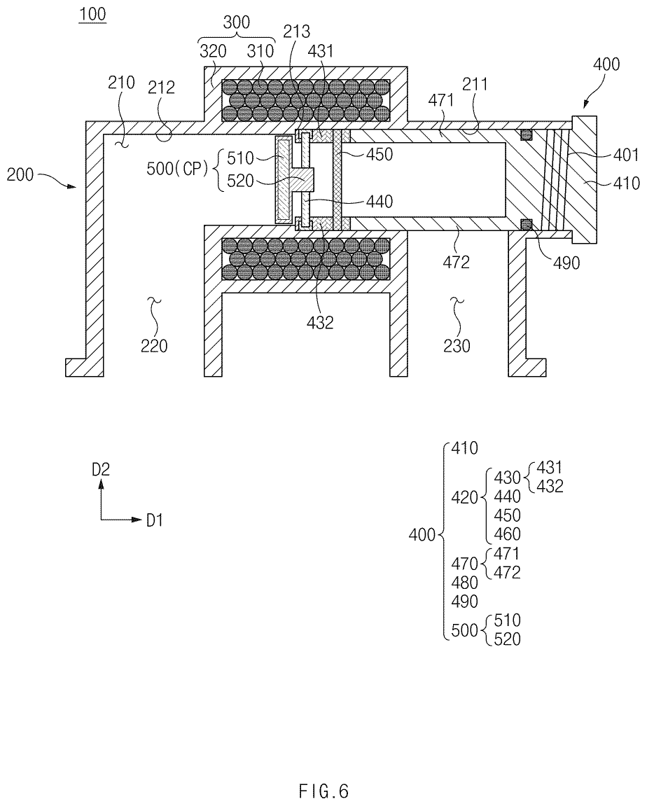

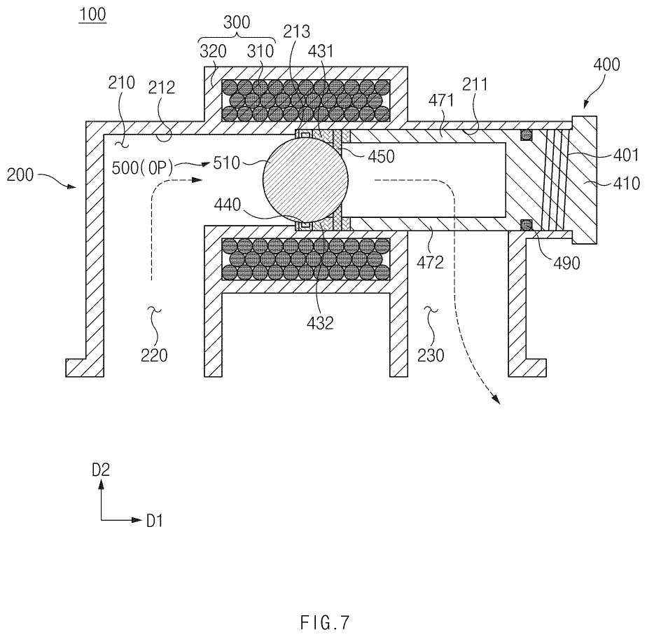

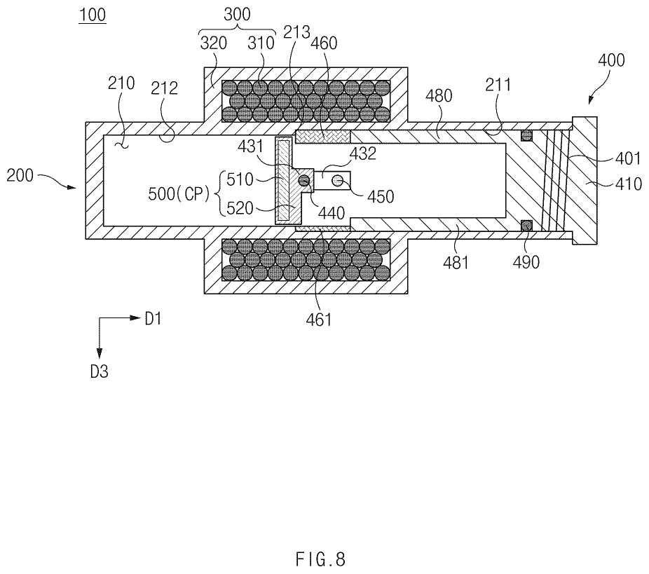

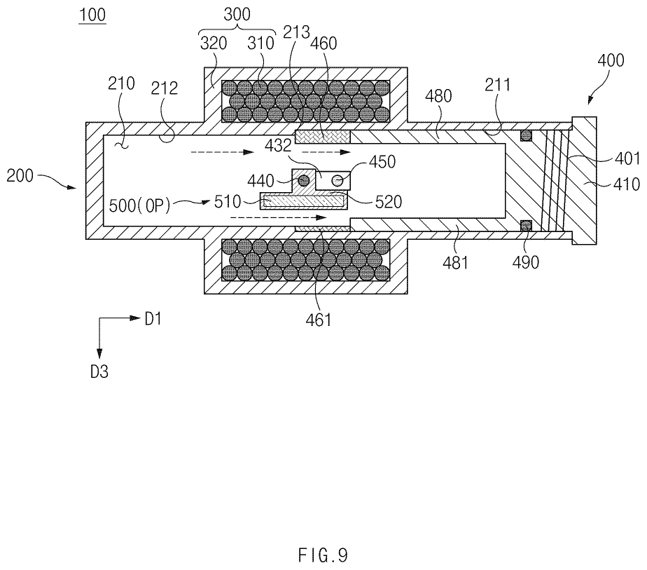

FIG. 6 is a vertical cross-sectional view of a valve when a valve disc is in a closed state according to an embodiment of the present disclosure. FIG. 7 is a vertical cross-sectional view of a valve when a valve disc is in an open state according to an embodiment of the present disclosure. FIG. 8 is a horizontal cross-sectional view of a valve when a valve disc is in a closed state according to an embodiment of the present disclosure. FIG. 9 is a horizontal cross-sectional view of a valve when a valve disc is in an open state according to an embodiment of the present disclosure.

Referring to FIGS. 6 to 9, a valve 100 according to an embodiment of the present disclosure of FIGS. 6 to 9 differs from the valve 100 according to an embodiment of the present disclosure of FIGS. 2 to 5 in that the cover area 410 and the disc holder area 420 of the valve cover 400 are separately formed.

Referring to FIGS. 6 to 9, the valve cover 400 may include the cover area 410, the disc holder area 420, the support connection area 470, the stopper connection area 480, the O-ring 490, and the valve disc 500.

The cover area 410, the support connection area 470, and the stopper connection area 480 may be integrally formed, and the disc holder area 420 may be inserted into the valve body 200 while coupled to the valve disc 500.

That is, the valve disc 500 and the disc holder area 420 may be inserted while being coupled toward the flow path 210 of the valve body 200, and the cover area 410, the support connection area 470, and the stopper connection area 480 integrally formed may be inserted toward the disc holder area 420.

In this example, the cover area 410, the support connection area 470, and the stopper connection area 480 that are integrally formed may rotate in a circumferential direction of the flow path 210 while in contact with the first inner surface 211 of the valve body 200.

The cover area 410 may include a portion inserted into the valve body 200 and formed as a bolt. For example, the portion of the cover area 410 inserted into the valve body 200 may include a screw line 401 formed in the outer circumferential surface thereof.

The first inner surface 211 of the valve body 200 may be engaged with a screw line of the cover area 410. That is, the valve body 200 may be formed in the shape of a nut, and the cover area 410 may be formed in the shape of a bolt or screw.

Due to a structure of an embodiment, the cover area 410 may be coupled to the valve body 200 within the flow path 210. Unlike the cover area 410 according to the embodiment of the present disclosure of FIGS. 2 to 5, the cover area 410 according to the embodiment of the present disclosure of FIGS. 6 to 9 may be directly coupled to the valve body 200 without a separate coupling member “F.”

When viewed from the one side D1 of the first direction, the cover area 410 according to an embodiment of the present disclosure may be coupled to the valve body 200 while rotating clockwise or counterclockwise.

Like the structure according to an embodiment of the present disclosure of FIGS. 2 to 5, the disc holder area 420 may include the first support area 431, the second support area 432, the rotary shaft 440, the open stopper member 450, and the closed stopper area 460.

However, unlike the disc holder area 420 according to an embodiment of the present disclosure of FIGS. 2 to 5, the disc holder area 420 according to an embodiment of the present disclosure of FIGS. 6 to 9 may further include a seating area 461.

The seating area 461 may be disposed on a side of the disc holder area 420 opposite to the closed stopper area 460 in a radially outward direction. The seating area 461 may have a thickness that is smaller than a thickness of the closed stopper area 460 in the third direction (D3 or the opposite direction to D3).

The seating area 461 may be seated in a groove formed by the first inner surface 211 and the fixing surface 213 and may be formed so as not to protrude toward the center of the flow path 210 further than the second inner surface 212.

As illustrated in FIGS. 8 and 9, this can be to prevent interference with the valve disc 500 when the valve disc 500 rotates from the closed position CP to the open position OP in the first rotational direction.

The reason why the disc holder area 420 according to an embodiment of the present disclosure in FIGS. 6 to 9 further includes the seating area 461 can be that the disc holder area 420 can be provided as a separate component from the cover area 410 and thus only the disc holder area 420 should be supported by the first inner surface 211 in a radially outward direction of the flow path 210.

Further, unlike the cover area 410 according to an embodiment of the present disclosure of FIGS. 2 to 5, the cover area 410 according to an embodiment of the present disclosure of FIGS. 6 to 9 may further include a seating support area 481.

The seating support area 481 may be disposed on an opposite side to the closed stopper area 460 in a circumferential direction of the cover area 410. The seating support area 481 may be a part for supporting the seating area 461 together with the fixing surface 213 in the first direction (D1 or the opposite direction to D1).

According to a structure of an embodiment of FIGS. 6 to 9, in the valve cover 400, even when the cover area 410 and the disc holder area 420 are provided as separate components, a position of the disc holder area 420 inside the flow path 210 may be fixed.

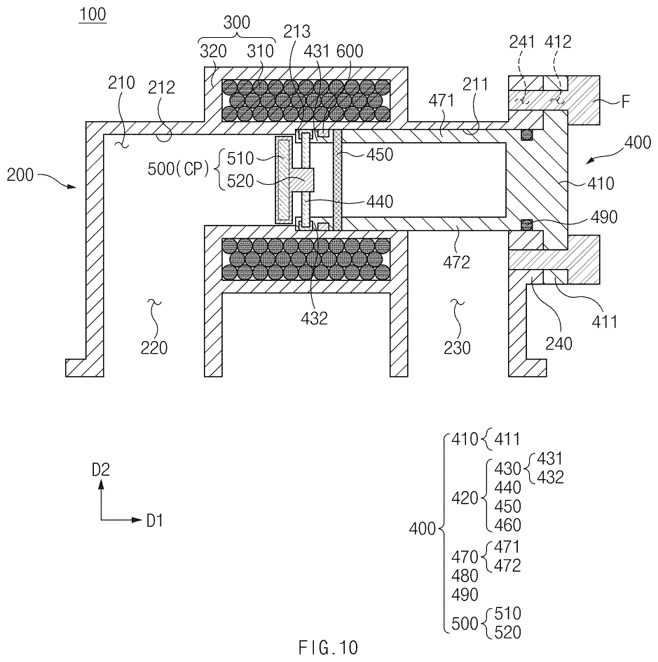

FIG. 10 is a vertical cross-sectional view of a valve when a valve disc is in a closed state according to an embodiment of the present disclosure.

Referring to FIG. 10, in some embodiments, the valve body 200 may further include an interference protrusion 600 interfering with the disc holder area 420 to prevent the disc holder area 420 from rotating about the center of the flow path 210.

In FIG. 10, the valve body 200 is illustrated as including the interference protrusion 600 protruding toward the disc holder area 420, but is not limited thereto, and the cover area 410 may include an interference protrusion 600 protruding toward the disc holder area 420.

As an example, the interference protrusion 600 of the valve body 200 may protrude from the first inner surface 211 or the fixing surface 213 toward the disc holder area 420, and the disc holder area 420 may include a protrusion groove into which the interference protrusion 600 is inserted.

As an example, the interference protrusion 600 of the cover area 410 may protrude from one surface in contact with the disc holder area 420 toward the disc holder area 420, and the disc holder area 420 may include a protrusion groove into which the interference protrusion 600 is inserted.

According to a structure of an embodiment, the position of the disc holder area 420 may be fixed by the valve body 200 or the cover area 410 inside the flow path 210, and the cover area 410 may be engaged with the first inner surface 211 of the valve body 200 to complete coupling between the cover area 410 and the valve body 200.

A structure other than the description of the valve 100 according to an embodiment of the present disclosure of FIGS. 6 to 9 can refer to the description of the valve 100 according to the embodiment of the present disclosure of FIGS. 2 to 5, for example.

According to an embodiment of the present disclosure, while a valve cover covers one side of a valve body, the valve cover and the valve body can be airtightly sealed therebetween, and thus airtightness of a valve may be improved.

According to an embodiment of the present disclosure, a disc holder area may rotatably support a valve disc, an open position and a closed position of the valve disc may be fixed, and thus assemblability of the valve may be improved.

According to an embodiment of the present disclosure, because the disc holder area may be formed integrally with the cover area, there can be no need to separately support the disc holder area on a flow path, and thus a structure of the valve may be simplified, and a weight and costs thereof may be reduced.

According to an embodiment of the present disclosure, because the disc holder area can be caught by a fixing surface of the valve body, there can be no need to separately support the disc holder area on the flow path, and thus the structure of the valve may be simplified, and the weight and the costs thereof may be reduced.

According to an embodiment of the present disclosure, when the disc holder area is formed as a separate component from the cover area, the disk holder area can be fixedly positioned between the cover area and the fixing surface, and thus the structure of the valve may be simplified, and the weight and the costs thereof may be reduced.

According to an embodiment of the present disclosure, the valve disc may be operated without other components such as a motor and a gear, and thus the structure is simple, and productivity may be further improved.

According to an embodiment of the present disclosure, a structure capable of thawing a fluid using a solenoid coil without a separate heater may be provided.

The above description is merely illustrative of the technical spirit of the present disclosure for example embodiments, and those skilled in the art to which the present disclosure belongs may make various modifications and changes without departing from the essential features of the present disclosure. A number of embodiments have been disclosed herein. It can be understood that various features of the different embodiments can be combined.

Thus, the example embodiments disclosed in the present disclosure are not intended to necessarily limit the technology spirit of the present disclosure but are intended to describe the present disclosure by way of some examples, and the scopes of the technical spirit of the present disclosure are not necessarily limited by these example embodiments. The scopes of protection of the present disclosure can be interpreted by the appended claims, and technical spirits within scopes equivalent thereto can be interpreted as being included in the scopes of the present disclosure.

What is claimed is:

1. A valve comprising:
a valve body having a flow path for fluid flow, wherein the flow path includes a portion extending in a first direction;
a solenoid coil located in the valve body to surround the flow path outside the flow path; and
a valve cover comprising:
a valve disc configured to open or close the flow path by the solenoid coil, wherein the valve disc comprises a magnetic material, and wherein the valve disc is rotatably provided on the flow path,
a disc holder area rotatably supporting the valve disc, and
a cover area mounted on the valve body to cover one side of the flow path in the first direction and supporting the disc holder area.

2. The valve of claim 1, wherein the disc holder area is inserted into the flow path from the one side of the flow path in the first direction.

3. The valve of claim 2, wherein the disc holder area is disposed between the cover area and the valve body in the first direction.

4. The valve of claim 2, wherein the disc holder area includes a rotary shaft extending in a second direction intersecting the first direction and rotatably supporting the valve disc.

5. The valve of claim 4, wherein the valve disc has a shape configured to cover the flow path, and wherein the valve disc is configured to rotate about the rotary shaft between a closed position at which the flow path is closed by the valve disc and an open position at which the flow path is open.

6. The valve of claim 5, wherein the disc holder area includes a support area supporting opposite ends of the rotary shaft and in contact with an inner surface of the valve body.

7. The valve of claim 6, wherein the support area includes a first support area supporting a first end of the rotary shaft and a second support area supporting a second end of the rotary shaft and disposed in parallel with the first support area.

8. The valve of claim 6, further comprising an open stopper member supported by the support area and extending in parallel to the rotary shaft, wherein, with a direction in which the valve disc is rotated from the closed position to the open position being referred to as a first rotational direction, the open stopper member being configured to interfere with the valve disc to prevent the valve disc located at the open position from further rotating in the first rotational direction.

9. The valve of claim 8, wherein, as viewed from a state of being spaced apart in the second direction, the open stopper member is in contact with one surface of the valve disc located at the open position.

10. The valve of claim 6, wherein the valve body comprises:
a first inner surface defining the flow path and in contact with the support area from a radially outer side of the flow path;
a second inner surface formed on an other side of the first inner surface in the first direction and protruding toward a center of the flow path further than the first inner surface; and
a fixing surface connecting the first inner surface and the second inner surface and in contact with one end of the support area.

11. The valve of claim 6, wherein the disc holder area further comprises a closed stopper area spaced apart from the rotary shaft in a third direction, wherein the third direction intersects the first direction and the second direction, and
wherein, with a direction in which the valve disc is rotated from the open position to the closed position being referred to as a second rotational direction, the closed stopper area being configured to interfere with the valve disc to prevent the valve disc located at the closed position from further rotating in the second rotational direction.

12. The valve of claim 11, wherein, as viewed in a state of being spaced apart in the second direction, the closed stopper area is in contact with one surface of the valve disc located at the closed position.

13. The valve of claim 6, wherein the valve cover further comprises a support connection area connecting the cover area and the support area, wherein at least two of the cover area, the support connection area, and the support area are integral.

14. The valve of claim 13, wherein the valve cover further comprises a stopper connection area connecting the cover area and a closed stopper area, wherein at least two of the cover area, the stopper connection area, and the closed stopper area are integral.

15. The valve of claim 4, wherein the valve disc comprises:
a rotation guide area connected to the rotary shaft; and
a disc area supported by the rotation guide area and comprising the magnetic material.

16. The valve of claim 1, further comprising an O-ring disposed between the valve body and the valve cover.

17. The valve of claim 1, wherein the valve cover comprises a cover hole extending in the first direction,
wherein the valve body comprises a body hole communicating with the cover hole,
wherein the valve further comprises a coupling member inserted into the cover hole and the body hole, and
wherein the valve cover and the valve body are coupled to each other by the coupling member.

18. The valve of claim 1, wherein the cover area comprises a portion inserted into the valve body and formed as a bolt, and wherein the cover area is coupled to the valve body inside the flow path.

19. The valve of claim 1, wherein the valve body or the cover area further comprises an interference protrusion protruding toward the disc holder area to prevent the disc holder area from rotating about a center of the flow path.

20. The valve of claim 1, further comprising a bobbin body provided outside the valve body to surround the solenoid coil, wherein the valve body and the bobbin body are integral.
